(19) United States
(12) Patent Application Publication
(10) Pub. No.: US 2004/0130744 A1
(43) Pub. Date: Jul. 8, 2004

(54) Online print with driverless web print server

(76) Inventors: Vincent Wu, Irvine, CA (US); Harpreet Singh, Orange, CA (US); Louis Ormond, Irvine, CA (US); Min Kuo, Temple City, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/336,211

(22) Filed: Jan. 3, 2003

(51) Int. Cl. G06F 3/12; G06F 15/00; G06F 11/30; H04L 9/32

(52) U.S. Cl. 358/1.15; 710/19; 718/100; 713/201

(57) ABSTRACT

A web based universal printing system that enables printing of documents without having the software application that was used to create the document on a client, or without the client being physically connected to the printer. The client using hypertext transfer protocol connects to a web page, selects a printer and finishing options associated with the selected printer, and then sends a document in its native format to a print server. The print server having the printer driver for the selected printer, converts the document to a print file and then sends the print file to the selected printer for printing. A jobs log database coupled to the print server logs system events and provides accounting capabilities. A job queue manager monitors the printer and print job and can report the status of the printer or the print job to the client.

### COPYRIGHT NOTICE

A portion of the disclosure of this patent document contains material which is subject to copyright protection. The copyright owner has no objection to the facsimile reproduction, by anyone of the patent document or the patent disclosure, as it appears in the Patent and Trademark Office patent files or records, but otherwise reserves all copyrights whatsoever.

### BACKGROUND OF THE INVENTION

The present invention relates generally to printing systems, and more particularly to a universal printing system with driverless printing to a remote printer via a print server.

Users of mobile devices such as Personal Digital Assistants (PDAs), laptops or portable personal computers, two way pagers, mobile phones, and other mobile devices can often access information over the internet. However, to print this information, the users of these devices usually need to either have a printer physically connected to the device, or the user must pre-store the document on an internet based storage that can only be accessed by special types of print devices for printing.

Another problem with mobile devices is that many documents must be printed using print drivers or the software used to create the document. Some documents may contain multiple document formats, for example a word processing document containing a graphic document. The mobile device may not have the document's native software for all of the document's formats. As mobile devices often have limited storage capabilities, it is often not feasible to install all of the necessary software programs to handle all of the formats.

Finally, because the device is mobile, a user may desire to print to the nearest printer, and the mobile device may not have a printer driver for the nearest printer installed. Most printers require that a document be converted to a print file containing printer control codes or commands. Thus for a mobile device to be able to print to any printer, it would have to have printer drivers for all known printers installed on it, which due to limited storage capabilities may degrade the usefulness of the device.

Thus, there is a need for a universal printing system that can enables a portable device, or any client, to select a printer and send a document to that printer without having the native applications for the document or print drivers for the printer.

### BRIEF SUMMARY OF THE INVENTION

In view of the aforementioned needs, the invention contemplates a universal printing system that uses a web based print server to process documents sent by a client. The web print server has a plurality of printers connected to it which may be at spatially diverse locations. The server performs the document to print file conversion and has the necessary printer drivers for all associated printers, obviating the need for printer drivers on the client. This enables a client to print documents without having the software drivers for the printer, or native application programs for the document installed on the client.

The preferred embodiment of the present invention is a printing system, comprising a print server, a printer communicatively coupled to the print server, and a client communicatively coupled to the print server. When the client submits a document to the web server to print, the web server converts the file to a print file and sends the print file to the printer to be printed. Typically, the client would log into the print server and select a destination printer. The file to be printed would then be uploaded to the printer server, normally using a hypertext transfer protocol (HTTP) and the print server then converts the document to a print file. The print server then sends the print file to the printer for printing, typically using either an Internet Print Protocol (IPP) or a line printer (LPR) method. The client may be a wireless client which would connect to the print server using an access point. Typically, the client and printer connect to the print server over the Internet. A queue manager is useful for controlling all transactions between the print server, client and printer. A job logs database would be coupled to the print server for maintaining accounting data.

Another embodiment of the present invention contemplates a method for a web server to process a print job, the steps comprising receiving a document for printing, converting the document to a print file, and submitting the print file to a selected printer operatively coupled to the web server. The document would normally be received over a network, such as the Internet. The web server may also obtain user identification, requiring a user to log in prior to submitting the document for printing. The web server normally queues the document and may also store the document as well. A job logs database tracks usage for accounting purposes.

One aspect of the present invention is driverless printing. A user may print a document with no printer driver installed on the PDA or portable device. Another aspect of the present invention is Internet document submission. A user may to print a document from the Internet with no physical local network connection. Still another aspect of the present invention is universal printing, or printing with multiple document formats. A user can print multiple document formats without having the software application that was used to create the document or a portion thereof on the mobile device, including but not limited to, image files such as BMP and TIFF, Uniform Resource Locators (URLs) such as www.yahoo.com, and Portable Document Format (PDF) files. Still yet another aspect of the present invention is centralized print service. The present invention enables a print service that is offered via one or more servers located at a central location, or at a plurality of locations, and giving users several options for paying for the service. A centralized print server can dispatch all print jobs anywhere. For example a user in Los Angeles may print a document to a central server in San Francisco which submits the document to a printer in Seattle. Another aspect of the present invention is accounting management. A service provider can charge by user and charges can be based on predetermined or agreed to prices. The accounting database can be retrieved from the print server. The database would typically be queried by a shared database such as Remote Procedure Call (RPC), and Extensible Markup Language/Simple Object Access Protocol (XML/SOAP) based interfaces can be offered. Still another aspect of the present invention is web service. The present invention can be implemented as an Extensible Markup Language (XML) based Web Service that can be used with other independent services to offer additional value-added printing services along with standard offerings.

Still other aspects of the present invention will become readily apparent to those skilled in this art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

While the present invention would typically be implemented in software, as those skilled in the art can readily appreciate, the present invention may be implemented in software, hardware, or a combination thereof.

### BRIEF DESCRIPTION OF THE SEVERAL VIEWS OF THE DRAWING

The accompanying drawings incorporated in and forming a part of the specification, illustrates several aspects of the present invention, and together with the description serve to explain the principles of the invention. In the drawings:

FIG. 1 is a block diagram of the network architecture contemplated by the preferred embodiment of the present invention;

FIG. 2 is a block diagram of the functional components of the present invention;

FIG. 3 is a flow chart of a process contemplated by the present invention;

FIG. 4 is an example of a user login screen;

FIG. 5 is an example screen snapshot of a screen for obtaining printing parameters;

FIG. 6 is an example screen snapshot of a screen for choosing a file to print;

FIG. 7 is an example of a Print and Device Status Screen;

FIG. 8 is an example of an Administrator Login Screen;

FIG. 9 is an example of a Printer Management Tab Screen;

FIG. 10 is an example of an Administrator Add Printer Screen;

FIG. 11 is an example of an Edit Printer Properties Screen;

FIG. 12 is an example of an Administrator Log Query Screen; and

FIG. 13 is an example of an Administrator Log Query Results Screen;

FIG. 14 is an example screen snapshot of a screen for obtaining printing parameters for an alternative embodiment;

FIG. 17 is an example of a Printer Management Tab Screen of an alternative embodiment with a cost per page option;

FIG. 18 is an example of an Administrator Add Printer Screen with a cost per page option;

FIG. 19 is an example of an Edit Printer Properties Screen with a cost per page option; and

FIG. 20 is an example of an Administrator Log Query Results Screen with a cost per page option.

### DETAILED DESCRIPTION OF INVENTION

Throughout this description, the preferred embodiment and examples shown should be considered as exemplars, rather than limitations, of the present invention.

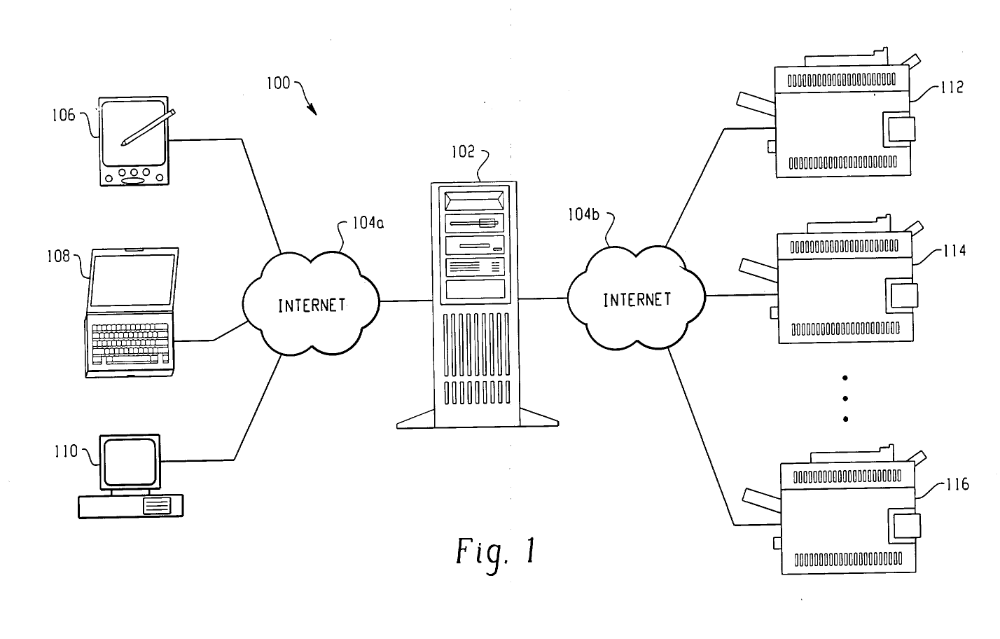

Referring first to FIG. 1, there is shown an example of a Network Architecture 100 contemplated by the present invention. A web print server 102 is connected over a network 104a to clients, the clients comprising a PDA 106, a notebook 108, and a workstation 110. Similarly, network 104b connects the web print server 102 to printers, the printers comprising a Black and White Laser Printer 112, a Color Laser Printer 114 and a Color Inkjet Printer 116. In the preferred embodiment, networks 104a and 104b are the Internet, thus the various clients and printers are not required to be spatially located within close proximity of each other. Furthermore, networks 104a and 104b may be wired, wireless, or a combination thereof.

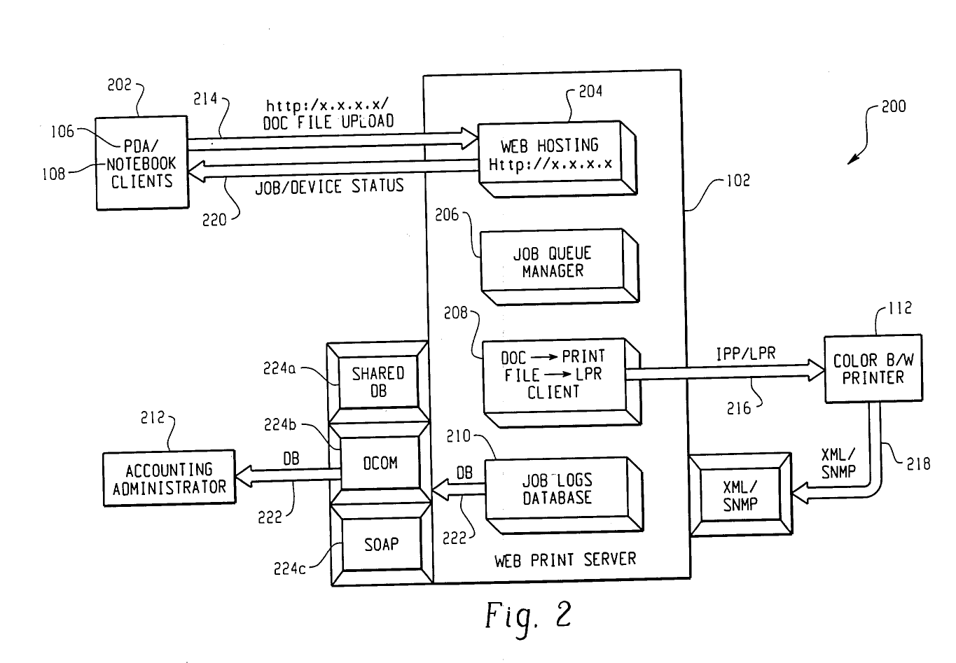

Referring now to FIG. 2, there is shown a block diagram 200 illustrating various functional components and interfaces. The web print server 102 is comprised of a WEB Hosting interface 204, Job Queue Manager 206, the Print Client Interface Module 208 and the Job Logs database 210. The WEB Hosting interface 204 is used to communicate with clients 202 such as the PDA 106 and the Notebook 108. The Job Queue Manager 206 controls all job flows. The Print Client Interface Module 208 is responsible for converting the document to a print file and then sending the print file to the printer via either an IPP or LPR method as shown by path 216. The Job Logs Database 210 stores the details of the various print jobs which can be exported along path 222 to the Accounting Administrator 212.

A user of a client 202, for example a PDA 106 or notebook 108, sends a document via the hypertext transfer protocol (HTTP) along path 214 to the WEB Hosting Interface 204 of the Web Print Server 102. Typically this is done by using a Web Browser and connecting to the web page by using the web page address such as http://x.x.x.x/ wherein the x.x.x.x represent the Internet Protocol (IP) address of the Web Server 102. The document is then queued by the Job Queue Manager 206. The Print Client Interface Module 208 removes the job from the queue and converts the document to a print file, sending the print file via path 216 either by an IPP or LPR method to the printer 112, the method used is dependent upon the printer. The Web Print Server 102 may further comprise an interface (not shown) to a document repository (not shown) wherein the document may be stored. The Web Print Server 102 monitors the printer or print job status by using either the Simple Network Management Protocol (SNMP) or SNMP encapsulated with XML (XML SNMP) to penetrate network firewalls. The status is sent from the printer 112 to the Web Printer Server 102 along path 218. A client 202 can retrieve the print device or print job status by using the web page interface, which is sent to the client 202 along path 220. The accounting administrator 212 can retrieve a detailed print log by opening a shared database (Shared DB) 224a, by distributed component object model (DCOM) 224b, or by Simple Object Access Protocol (SOAP) from the Job Logs Database 210 as shown by path 222.

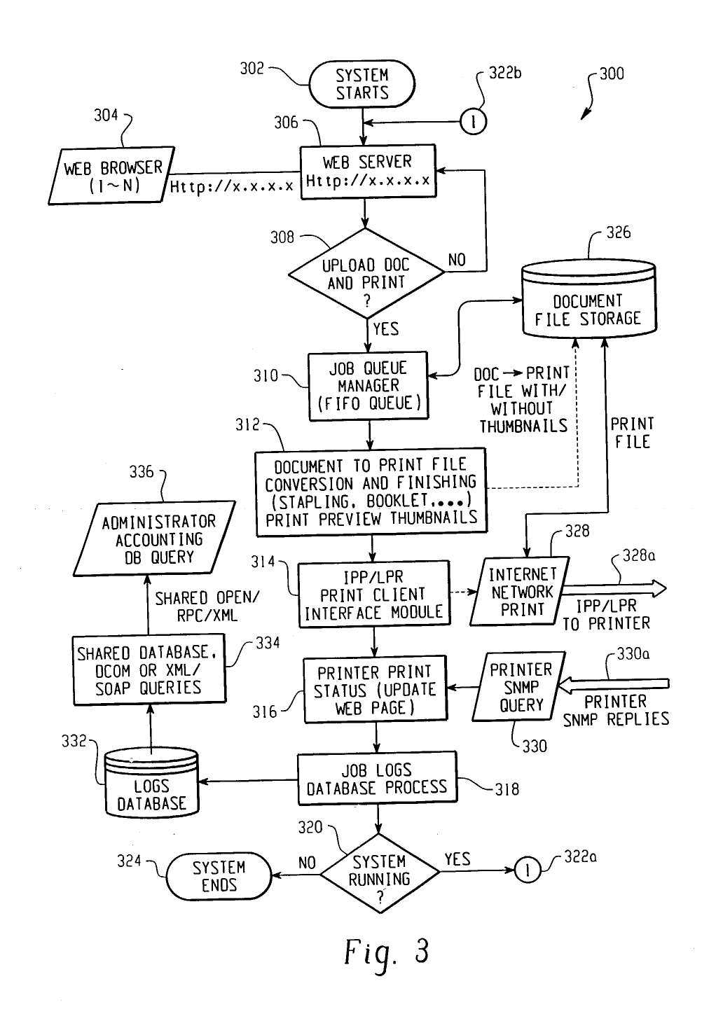

Referring to FIG. 3, there is illustrated a flow chart 300 of a method of the present invention. The system starts at step 302. At step 306 the Web Print Server 102 waits for a document. At step 304, a Web Browser contacts the Web Print Server and sends a file to step 306. At step 308 it is determined whether a document was uploaded for printing. If not, then the process returns to step 306. If a file was uploaded for printing, then the file at step 310 is forwarded to the Job Queue Manager 206. Typically, the Job Queue Manager is a First in First Out (FIFO) Queue, however, other types of queues, for example queues that enable a user or administrator to prioritize print jobs are acceptable. At step 312 the document is converted to a print file along with finishing options, and if appropriate print preview thumbnails. After conversion, at step 314 the file is sent by the Print Client Interface Module 208 is sent to Internet Network Print 328 by IPP or LPR to the printer as indicated by arrow 328a. At step 316 the Printer Print Status is updated. Upon sending an inquiry, the Printer SNMP replies as indicated by arrow 330a to block 330 which then arrives at block 316, which updates the Web Page of the Web Browser. At step 318 the Job Logs Database processes the data for the print job. If at step 320 the system is still running then the process returns to step 306 via the path of 322a and 322b. If at step 320 the system is not running, then at step 324 the process ends.

An alternative option is shown at step 326 when there is document file storage. At step 310, The Job Queue Manager 206 may send the document for file storage. Additionally, or in the alternative, at step 312 after the conversion is performed, the document, print file, or combination of document and print file, with or without preview thumbnails are sent to block 326 for document file storage, which then routes the print file to block 328 for printing.

As shown at step 332, data from the Logs Database may be sent via Shared Database, DCOM or XML/SOAP Queries as shown in step 334 to an accounting administrator as shown in block 336.

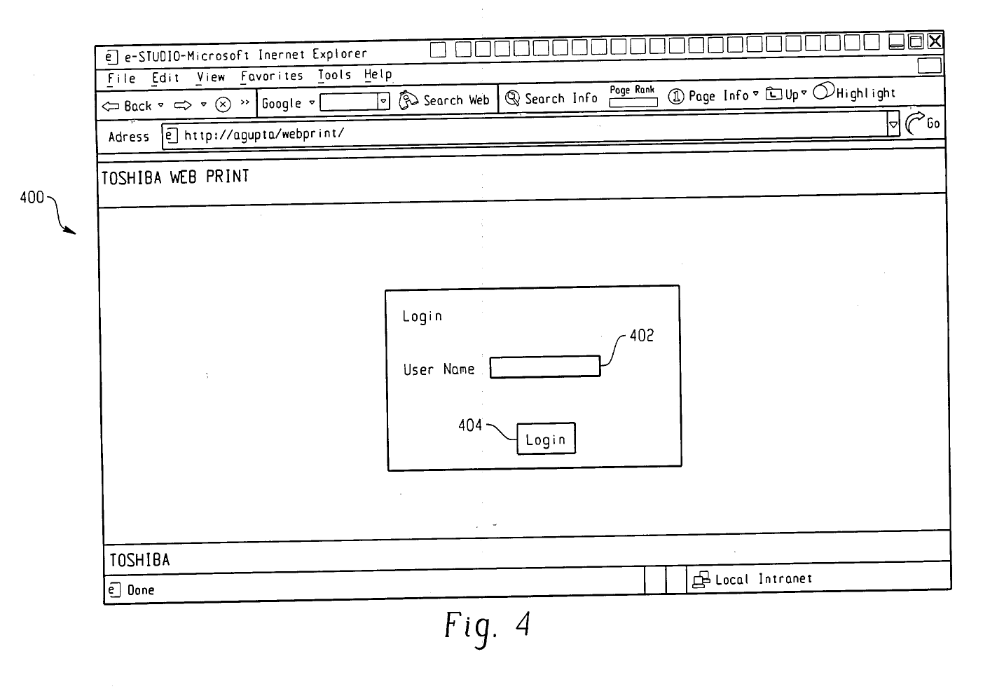

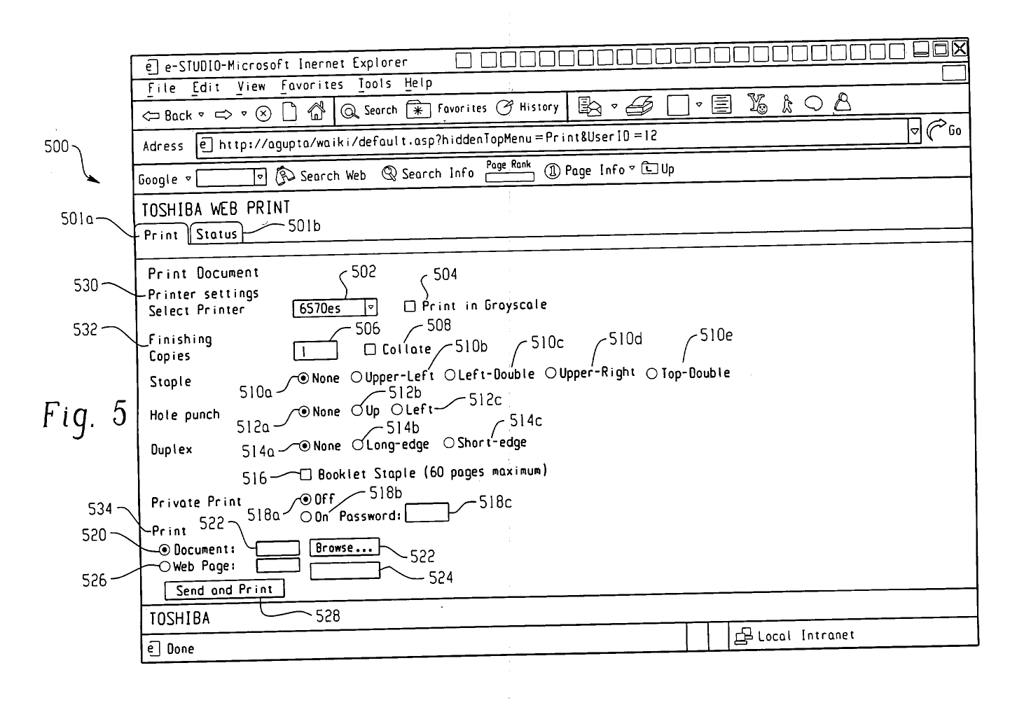

FIG. 4 shows an example of a user login screen. A user needs to provide a user ID to identify the user to the server. The user has a couple of options for logging in. The user may enter the URL http://x.x.x.x where “x.x.x.x” is the IP address of the Web Print Server 102 and fill in the screen 400, or may go to the print screen directly by entering the URL http://x.x.x.x/default.asp?UserID=yyyy, where yyyy is the user ID. When filling in the screen 400, the User Name 402 is filled in with the user identification and the user then selects the login button 404. Optionally, the user may be prompted to provide a password or other additional means of authentication may be used.

After the user is logged in, a Web Print screen is displayed, which when tab 501a is selected is the User Print Tab Screen 500. The first section of the screen 500 is the printer settings section 530 that enables the user to select a printer and the printer settings. The user selects a printer using the drop down menu 502 and selects a printer from a list. The printers and menu 502 are setup by an administrator. When the printer selected in menu 502 is a color printer, then the user may check checkbox 502 to print in gray scale. The checkbox 504 is only visible if the printer has color capabilities.

The next section of the User Print Tab Screen 500 is the Finishing Section 532 used to obtain finishing parameters of the print job. The copies 506 is for the number of copies to be printed of the uploaded document and the collate checkbox 508 if checked indicates that the document needs to be collated in the case of multiple copies. The stapling option is selected by radio buttons for None 510a, Upper Left 510b, Left Double 510c, Upper Right 510d and Top Double 510e respectively. The Hole Punch option is selected by selecting of the radio buttons None 512a, Up 512b, or Left 512c respectively. The Duplex option is selected by selecting one of radio buttons None 514a, Long-edge 514b, or Short-edge 516c respectively. Booklet staple 516 may be selected, which for the printer used in the present example may be selected for a maximum of 60 pages. The private print options are selected by radio buttons for Off 518a or On 518b, and if On 518b is selected then a password is entered in text box 518c.

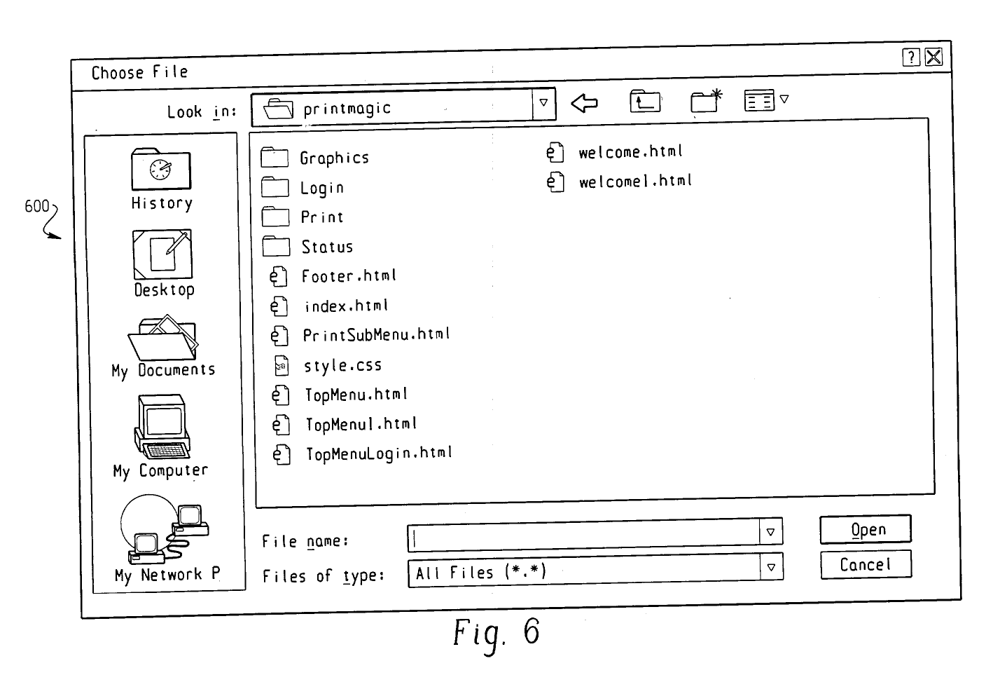

The print section 534 is used to select the object to be printed. Document radio button 520 is selected for a document, whereas web page radio button 526 is selected to print a web page. If radio button 520 is selected, the document file name is input in box 522, or by selecting browse button 524 the Choose File Screen 600 of FIG. 6 is displayed. If the web page radio button 526 is selected, then the web page address or URL is input in text box 524. Finally, after the printer, finishing options, and object to print have been selected, pressing the Send and Print push button 528 sends the document to the web print server 102.

FIG. 7 shows an example of a User Print and Device Status Screen 700. This screen is accessed after the user logs in by selecting tab 501b of the Web Print Screen. The Screen 700 is divided into two sections, the first the Current Jobs section 701, and the second section is the Device Status section 703. The select printer box 702 is a drop down menu used to obtain a list of printers, and to select the printer to monitor. This menu is normally setup in advance by a system administrator.

Under the current jobs section 701, there is given a list of jobs for the current user and selected printer. The list has columns for document name 704, status 706, pages 708, document status 710, and the date and time submitted 712. The user may delete a print job by checking check box 714 for the appropriate document and then selecting the delete pushbutton 716.

The device status section 703 has four fields. These are the device status 716, contact information with the name 718 and phone number 720 of the contact person, and alerts 722 for the device. The alerts field 722 shows none if there are no active alerts for the device, or a list of active alerts if device alerts are present.

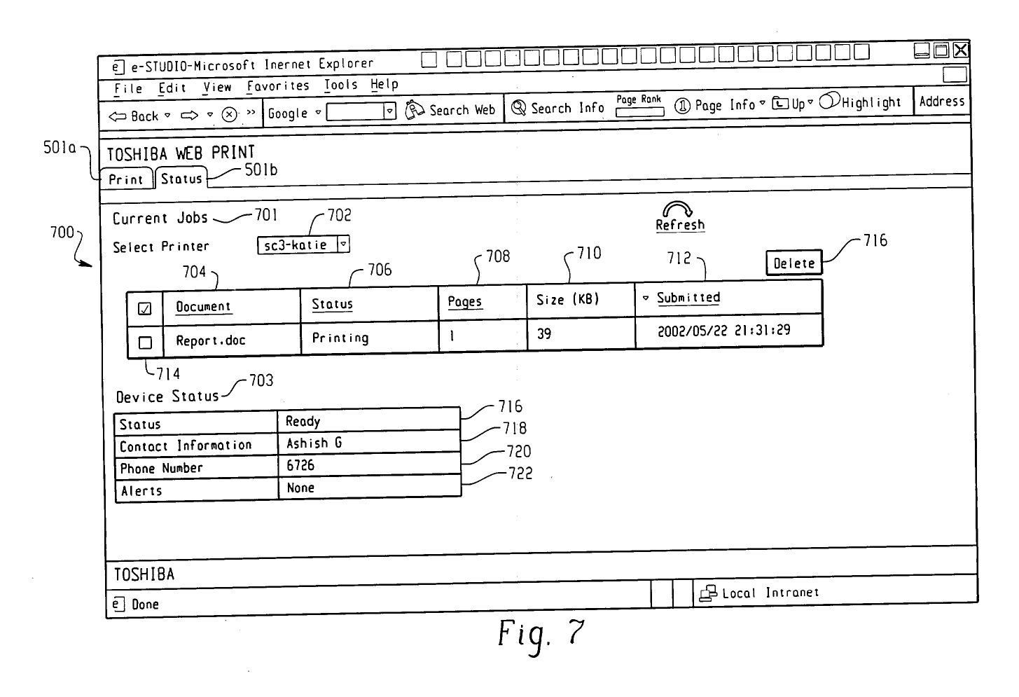

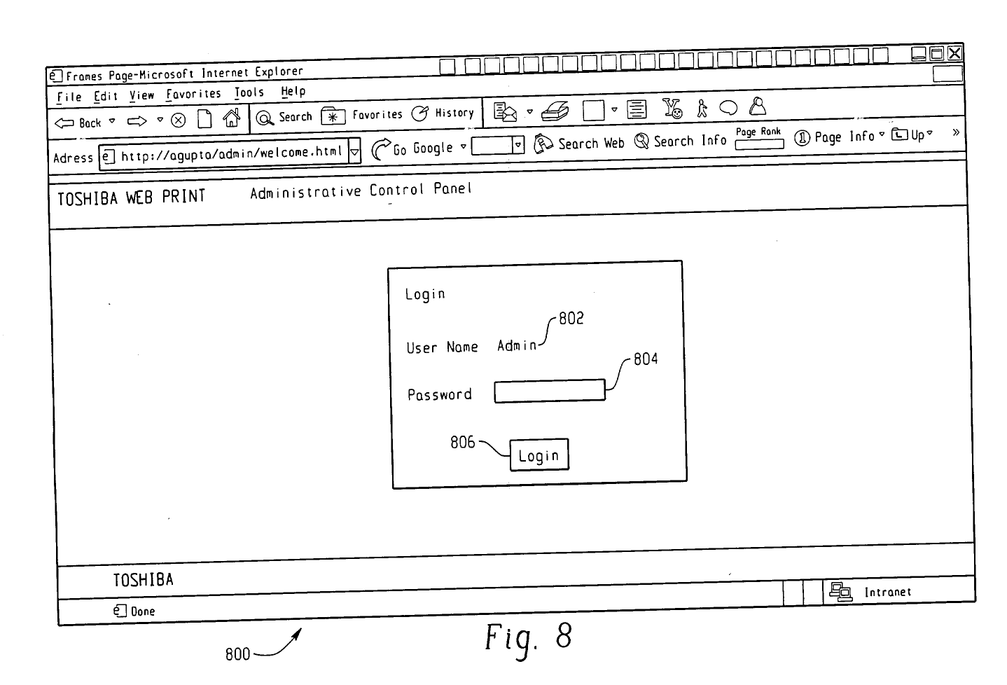

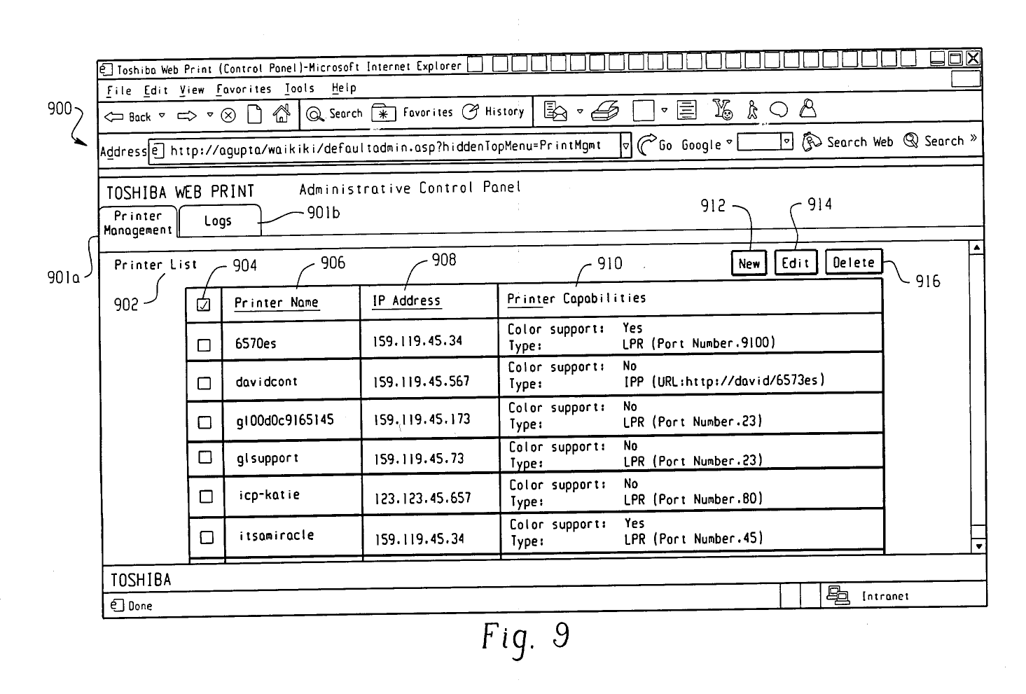

FIG. 8 is an example of a Administrator Login Screen 800. A system administrator can enter the Administrative Control Panel (not shown) by entering the URL http://x.x.x.x/admin, where “x.x.x.x” is the IP address of the web print server 102. As shown in FIG. 8, the user name 802 is admin and static. The password text box 804 is a mandatory input field for entering the administrator password and authenticating the administrator. After the password text box 804 is filled in with the proper password, selecting the login pushbutton 806 causes the password to be authenticated, and if authenticated, the administrator goes to the next screen, the Administrative Control Panel (FIGS. 9-13).

FIG. 9 shows the Printer Management Tab Screen 900 which is displayed when the management tab 901a of the Administrative Control Panel is selected. Under the heading Printer List, 902, there is listed the printers associated with the web print server 102. The list comprises a plurality columns. The first column being a checkbox 904 for selecting printers to be edited or deleted when selecting the Edit pushbutton 914 and the Delete pushbutton 916. The Printer Name column 906 displays the name assigned to each printer, the IP address 908 shows the IP address of the printer, printer capabilities 910 shows whether the printer supports color printing and the type of printer. For example, for line printers, the printer capabilities 910 column would show the abbreviation LPR and the port number, whereas for an Internet printer the abbreviation IPP with the URL for the printer is displayed. The new button 912 is used to add new printers.

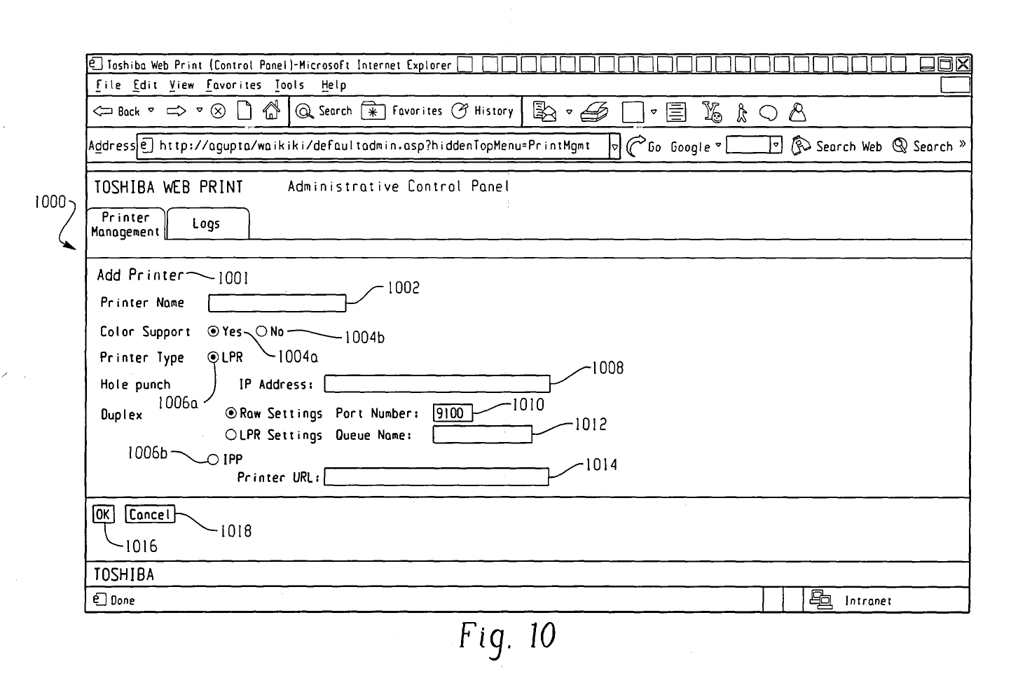

When in FIG. 9 the new button 912 is selected, the Add Printer Screen 1000 of FIG. 10 is displayed. The heading Add Printer 1001 is displayed to inform the administrator that a new printer is being added. The printer name 1002 is a text box to input the network name of the printer. Radio button yes 1004a denotes the printer supports color printing while radio button no 1004b is selected to denote the printer does not support color printing. Radio buttons are also used to select the printer type. If the printer is an LPR printer, then button 1006a is selected, if the printer is an IPP printer, then button 1006b is selected. The IP address is input into the IP address text box 1008, which is mandatory if the LPR printer button 1006a is selected. The port number text box 1010 contains the port number for LPR printing, which is mandatory if the LPR radio button 1006a is selected. The default value of the port number text box 1010 is 9100. The Queue Name 1014 is the host name for LPR printing. The Printer URL text box 1014 contains the IPP URL for IPP printing and is a mandatory field if the IPP radio button 1006b is selected. The OK pushbutton 1016 is used to save the changes, and the Cancel pushbutton 1018 aborts the transaction.

When in FIG. 9 the Edit pushbutton 914 is selected, the Edit Printer Properties Screen 1100 as shown in FIG. 11 is displayed. The heading Edit Printer 1101 is displayed on the top of the screen 1100 to inform the administrator that printer properties are being edited. The remaining fields on the screen 1100 are the same as defined for the Add Printer Screen 1000 (FIG. 10).

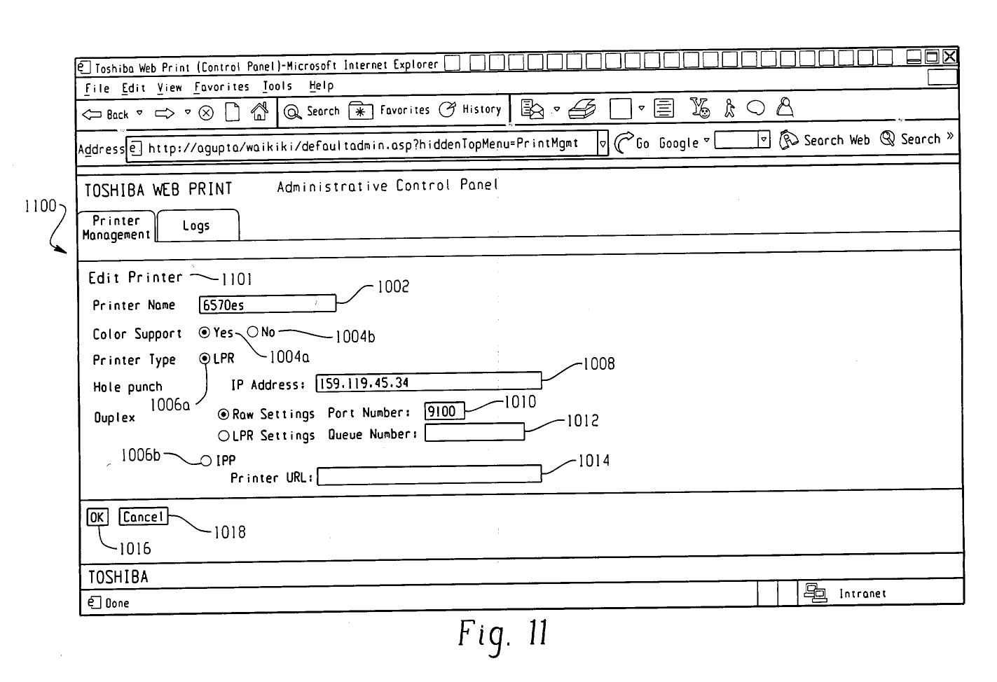

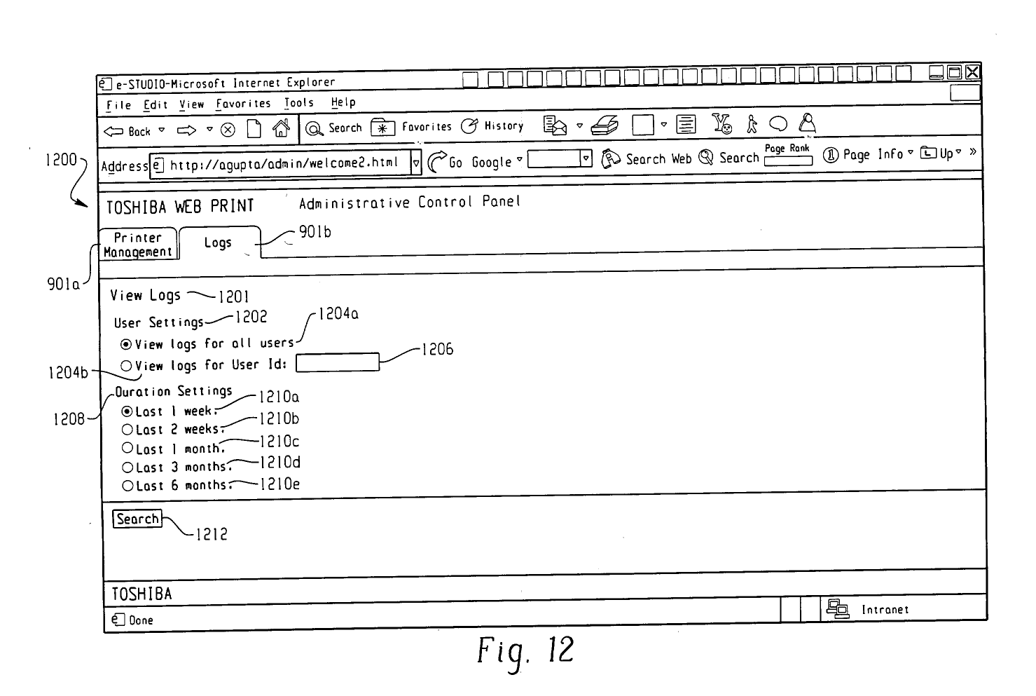

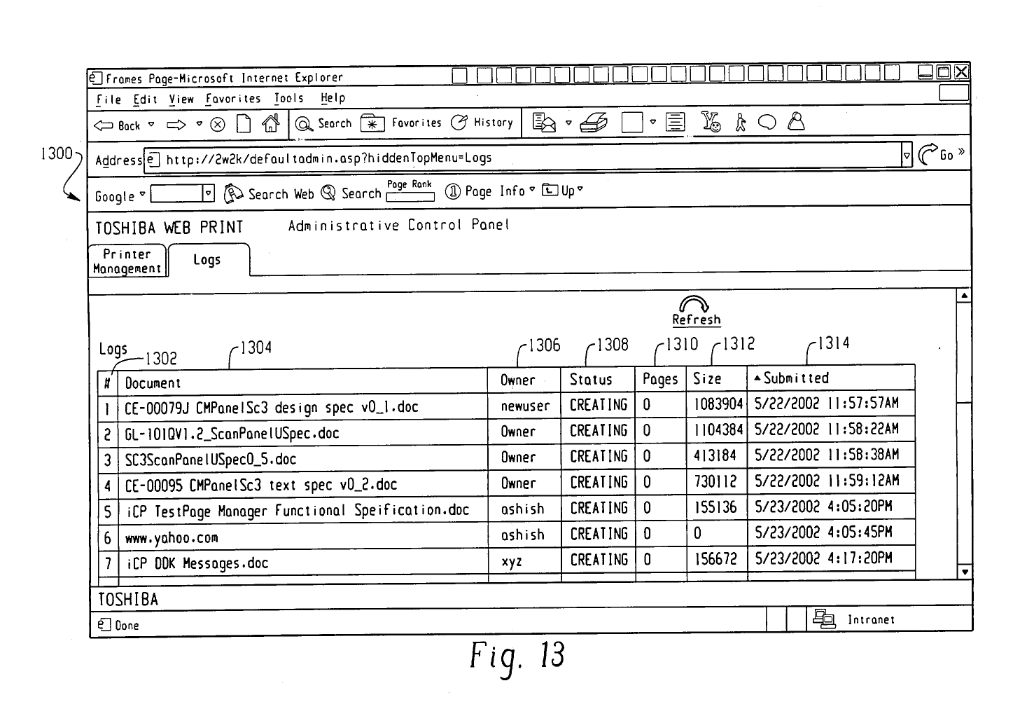

FIG. 12 is an example of the Log Query Screen 1200. This screen is reached by selecting the Logs tab 901b of the Administrative Control Panel. The heading View Logs 1201 is at the upper left corner of the screen to denote this screen is for viewing logs. The upper section of the screen is the user settings section 1202. Radio buttons 1204a and 1204b are selected to display logs either for all users or for an individual user respectively. If the individual user radio button 1204b is selected, the user id is input into text box 1206. The duration settings section 1208 comprises a plurality of radio buttons to indicate the time period for viewing logs. The user may select the duration of Last 1 week 1210a (default), Last 2 weeks 1210b, Last 1 Month 1210c, Last 3 months 1210d, or Last 6 months 1210e. Selecting the Search Button 1212 displays the Logs Query Results Screen 1300, as shown in FIG. 13.

The Logs Query Results Screen 1300 lists the records matching the parameters input in the Log Query Screen 1200 (FIG. 12). The records are displayed in columns under the headings Job ID 1302, Document 1304, Status 1306, Owner 1308, Pages 1310, Size 1312, and Submitted Time 1314.

Referring now to FIGS. 14-20, there is illustrated an alternative embodiment of the present invention having an option to charge a user a cost associated with the print job. The cost may be any suitable cost accounting method, including but not limited to a fixed cost per job, or as illustrated in FIGS. 14-20, a cost per page.

Referring first to FIG. 14, there is illustrated an example screen snapshot 1400 for obtaining parameters for the print job. This screen appears after the user is logged in, and tab 501a is selected. The user selects a printer using the drop down menu 1401 and selects a printer from a list. The printers and menu 1401 are setup by an administrator.

The user may then select finishing options for the print job. The copies 1402 is for the number of copies to be printed of the uploaded document and the collate checkbox 1404 if checked indicates that the document needs to be collated in the case of multiple copies. The stapling option is selected by a drop down menu 1406 and a preview of the selected option is shown in preview box 1408. The Hole Punch option is selected by selecting from drop down menu 1410, and a preview of the selected option is also shown in preview box 1408. Duplex options are selected from drop down menu 1412 and a preview of the selection option is shown in preview box 1414. Booklet staple checkbox 1416 may be selected, which for the printer used in the present example may be selected for a maximum of 60 pages. The private print options are selected by radio buttons for Off 1418a or On 1420, and if On 1420 is selected then a password is entered in text box 1422.

After selecting a printer and finishing options, the user would then select the object to be printed. Document radio button 1426 is selected for a document, whereas web page radio button 1430 is selected to print a web page. If radio button 1426 is selected, the document file name is input in box 1434, or by selecting browse button 1428, the Choose File Screen 600 of FIG. 6 is displayed. If the web page radio button 1430 is selected, then the web page address or URL is input in text box 1436. Finally, after the printer, finishing options, and object to print have been selected, pressing the Send and Print push button 1432 sends the document to the web print server 102.

If when the Send and Print push button 1432 is selected and the printer is not responding, then the alert box 1500 as shown in FIG. 15 is displayed. If the printer is responding, then as shown in FIG. 16 a cost dialog box 1600 is displayed. The user may accept the cost by selecting button 1602 or cancel the print job by pressing button 1604.

FIG. 17 shows the Printer Management Tab Screen 1700 which is displayed when the management tab 901a of the Administrative Control Panel is selected with the printing cost per page option. Under the heading Printer List, 902, there is listed the printers associated with the web print server 102. The list comprises a plurality columns. The first column being a checkbox 904 for selecting printers to be edited or deleted when selecting the Edit pushbutton 914 and the Delete pushbutton 916. The Printer Name column 906 displays the name assigned to each printer, the IP address 908 shows the IP address of the printer. The printing cost per page is shown in column 1702, the printer capabilities column 910 shows whether the printer supports color printing and the type of printer. For example, for line printers, the printer capabilities 910 column would show the abbreviation LPR and the port number, whereas for an Internet printer the abbreviation IPP with the URL for the printer is displayed. The new button 912 is used to add new printers.

When in FIG. 17 the new button 912 is selected, the Add Printer Screen 1800 of FIG. 18 is displayed. This screen is similar to the Add Printer Screen 1000 of FIG. 10. The heading Add Printer 1001 is displayed to inform the administrator that a new printer is being added. The printer name 1002 is a text box to input the network name of the printer. Radio button yes 1004a denotes the printer supports color printing while radio button no 1004b is selected to denote the printer does not support color printing. The printing cost, which in this embodiment is cost per page, is entered in text box 1802. Radio buttons are also used to select the printer type. If the printer is an LPR printer, then button 1006a is selected, if the printer is an IPP printer, then button 1006b is selected. The IP address is input into the IP address text box 1008, which is mandatory if the LPR printer button 1006a is selected. The port number text box 1010 contains the port number for LPR printing, which is mandatory if the LPR radio button 1006a is selected. The default value of the port number text box 1010 is 9100. The Queue Name 1014 is the host name for LPR printing. The Printer URL text box 1014 contains the IPP URL for IPP printing and is a mandatory field if the IPP radio button 1006b is selected. The OK pushbutton 1016 is used to save the changes, and the Cancel pushbutton 1018 aborts the transaction.

When in FIG. 17 the Edit pushbutton 914 is selected, the Edit Printer Properties Screen 1900 as shown in FIG. 19 is displayed. The heading Edit Printer 1101 is displayed on the top of the screen 1100 to inform the administrator that printer properties are being edited. The remaining fields on the screen 1100 are the same as defined for the Add Printer Screen 1800 (FIG. 18).

To view printer logs in this embodiment, the same screen as exemplified in FIG. 12 may be used. This screen is reached by selecting the Logs tab 901b of the Administrative Control Panel. The heading View Logs 1201 is at the upper left corner of the screen to denote this screen is for viewing logs. The upper section of the screen is the user settings section 1202. Radio buttons 1204a and 1204b are selected to display logs either for all users or for an individual user respectively. If the individual user radio button 1204b is selected, the user id is input into text box 1206. The duration settings section 1208 comprises a plurality of radio buttons to indicate the time period for viewing logs. The user may select the duration of Last 1 week 1210a (default), Last 2 weeks 1210b, Last 1 Month 1210c, Last 3 months 1210d, or Last 6 months 1210e. However, in this embodiment, selecting the Search Button 1212 displays the Logs Query Results Screen 2000, as shown in FIG. 20.

The Logs Query Results Screen 2000 lists the records matching the parameters input in the Log Query Screen 1200 (FIG. 12). The records are displayed in columns under the headings Job ID 1302, Document 1304, Status 1306, Printer Name 2002, Status 2010, Pages 1310, Copies 2006, Total Cost 2008, Size 1312, and Submitted Time 1314.

While the aforementioned embodiments used IP to demonstrate process flows and network connectivity, as those skilled in the art can readily appreciate the present invention is capable of supporting several wireless networking technologies such as 802.11a, 802.11b, 802.11g (also known as WiFi) as well. Network access may be provided at hot spots or public places such as coffee-shops, libraries, hotels, conference centers, etc. for connecting wireless stations to a network, such as the Internet. The present invention may be used in conjunction with the network access to offer driverless and universal printing services via a printer available at the installation, the nearest available printer, or any printer with which a user is authorized.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of the ordinary skill in the art to utilize the invention in various embodiments and with various modifications as are suited to the particular use contemplated. All such modifications and variations are within the scope of the invention as determined by the appended claims when interpreted in accordance to the breadth to which they are fairly, legally and equitably entitled.

What is claimed is:

1. A method for a web server to process a print job, the steps comprising:
receiving a document for printing;
converting the document to a print file; and
submitting the print file to a selected printer operatively coupled to the web server.

2. The method of claim 1 wherein the document is received over a network.

3. The method of claim 2 wherein the network is the internet.

4. The method of claim 1, the steps further comprising obtaining user identification.

5. The method of claim 4 wherein the obtaining user identification step comprises requiring a user to log in.

6. The method of claim 1, the steps further comprising queuing the document.

7. The method of claim 1, the steps further comprising storing the document.

8. The method of claim 1, the steps further comprising updating a job logs database.

9. The method of claim 1, wherein the receiving step receives the document via a Hypertext Transfer Protocol.

10. The method of claim 1 wherein the submitting step submits the document to the printer by one of an internet print protocol method and a line printer method.

11. The method of claim 1, the steps further comprising monitoring at least one of device status and print job status.

12. The method of claim 11, wherein the receiving step comprises receiving the document from a client, the steps further comprising sending the at least one of the device status and print job status to the client.

13. The method of claim 1, further comprising obtaining user consent for a cost associated with printing the document.

14. The method of claim 13 wherein the cost is a cost per page.

15. A computer-readable medium, comprising
means adapted for receiving a document for printing;
means adapted for converting the document to a print file; and
means adapted for submitting the print file to a selected printer.

16. The computer-readable medium of claim 15 wherein the document is received over a network.

17. The computer-readable medium of claim 19 wherein the network is the internet.

18. The computer-readable medium of claim 15, the further comprising means adapted for obtaining user identification.

19. The computer-readable medium of claim 18 wherein the means adapted for obtaining user identification step comprises means adapted for requiring a user to log in.

20. The computer-readable medium of claim 15, the further comprising means adapted for queuing the document.

21. The computer-readable medium of claim 15, the further comprising means adapted for storing the document.

22. The computer-readable medium of claim 15, the further comprising means adapted for updating a job logs database.

23. The computer-readable medium of claim 15, wherein the means adapted for receiving receives the document via a Hypertext Transfer Protocol.

24. The computer-readable medium of claim 15 wherein the means adapted for submitting submits the document to the printer by one of an internet print protocol method and a line printer method.

25. The computer-readable medium of claim 15, the further comprising means adapted for monitoring at least one of device status and print job status.

26. The computer-readable medium of claim 25, wherein the means adapted for receiving comprises receiving the document from a client, the means adapted for monitoring at least one of device status and print job status further comprising means adapted for sending the at least one of the device status and print job status to the client.

27. The computer-readable medium of claim 15, further comprising means adapted to obtaining user consent for a cost associated with printing the document.

28. The computer-readable medium of claim 27 wherein the cost is a cost per page.

29. A method for printing a document, the steps comprising:
accessing a web server;
selecting a printer operatively coupled to the web server; and
sending a document to the web server.

30. The method of claim 29 wherein the web server is connected by an internet to the printer.

31. The method of claim 29, the accessing step using a hypertext transfer protocol.

32. The method of claim 29, the accessing step further comprising logging into the web server.

33. The method of claim 29, the selecting step further comprising selecting finishing parameters.

34. The method of claim 29, the sending step further comprising selecting the document to send to the web server.

35. The method of claim 29, the sending step further comprises, converting the document to a print file by the web server.

36. The method of claim 35, the sending step further comprises sending the print file to the printer by the web server.

37. The method of claim 29 further comprising monitoring at least one of device status and print job status.

38. The method of claim 37 wherein the monitoring step comprises sending a hypertext transfer protocol message to the web server.

39. The method of claim 29, further comprising obtaining user consent for a cost associated with printing the document.

40. The method of claim 39 wherein the cost is a cost per page.

41. A computer-readable medium, comprising:
means adapted for accessing a web server;
means adapted for selecting a printer operatively coupled to the web server; and
means adapted for sending a document to the web server.

42 The computer-readable medium of claim 41 wherein the web server is connected by an internet to the printer.

43. The computer-readable medium of claim 41, the means adapted for accessing uses a hypertext transfer protocol.

44. The computer-readable medium of claim 41, the means adapted for accessing further comprising means adapted for logging into the web server.

45. The computer-readable medium of claim 41, the means adapted for selecting further comprises means adapted for selecting finishing parameters.

46. The computer-readable medium of claim 39, the means adapted for sending further comprises means adapted for selecting the document to send to the web server.

47. The computer-readable medium of claim 41, the means adapted for sending further comprises means adapted for converting the document to a print file by the web server.

48. The computer-readable medium of claim 41, the means adapted for sending further comprises means adapted for sending the print file to the printer by the web server.

49. The computer-readable medium of claim 41 further comprising means adapted for monitoring at least one of device status and print job status.

50. The computer-readable medium of claim 49 wherein the means adapted for to monitoring comprises means adapted for sending a hypertext transfer protocol message to the web server.

51. The computer-readable medium of claim 41, further comprising means adapted to obtaining user consent for a cost associated with printing the document.

52. The computer-readable medium of claim 51 wherein the cost is a cost per page.

53. A web server, comprising:
communications means adapted to receive a document from an external source;
converting means for converting the document to a print file; and
printer communication means for sending the print file to an external printer.

54. The web server of claim 53 further comprising a job queue manager wherein the job queue manager controls all communications between the web server and the printer.

55. The web server of claim 54 wherein the external source is connected to the web server via an internet.

56. The web server of claim 55 wherein the printer is connected to the web server via an internet.

57. The web server of claim 56 further comprising a job logging database.

58. The web server of claim 57 further comprising means adapted to obtain at least one of printer status and print job status.

59. The web server of claim 58 wherein the means adapted to obtain at least one of printer status and print job status further comprises means uses one of a simple network management protocol and encapsulation with extensible markup language to obtain the at least one of printer status and print job status.

60. The web server of claim 59 wherein the job logging database has means suitably adapted to be accessed by one of the group consisting of extensible markup language, distributed component object model, and simple object access protocol.

61. The web server of claim 53 wherein the external source is connected to the web server via an internet.

62. The web server of claim 53 wherein the printer is connected to the web server via an internet.

63. The web server of claim 53 further comprising a job logging database.

64. The web server of claim 53 further comprising means adapted to obtain at least one of printer status and print job status.

65. The web server of claim 64 wherein the means adapted to obtain at least one of printer status and print job status further comprises means uses one of a simple network management protocol and encapsulation with extensible markup language to obtain the at least one of printer status and print job status.

66. The web server of claim 67 wherein the means adapted to obtain at least one of printer status and print job status is responsive to the communication means, wherein when a hypertext transfer protocol message is received by the communication means the means adapted to obtain at least one of the printer status and print job status sends the at least one of the printer status and print job status to the communications means, and the communication means sends the at least one of the printer status and print job status to the external source.

67. The web server of claim 53, further comprising means adapted to obtaining user consent for a cost associated with printing the document.

68. The computer-readable medium of claim 67 wherein the cost is a cost per page.

69. A printing system, comprising:
a print server;
a printer communicatively coupled to the print server; and
a client communicatively coupled to the print server;
wherein the client submits a document to the web server to print, the web server converts the file to a print file and sends the print file to the printer to be printed.

70. The printer system of claim 69 wherein the client uses a hypertext transfer protocol to submit the document to the web print server.

71. The printer system of claim 69 wherein the print server is connected to the client by an internet and the print server is connected to the printer by the internet.

72. The printer system of claim 69 further comprising an accounting database operatively coupled to the print server.

73. The printer system of claim 69 wherein the client is a wireless client, the system further comprising an access point for handling communications between the client and the print server.

74. The printer system of claim 73 wherein the client and access point are 802.11 complaint.

75. The printer system of claim 74 further comprising an accounting database operatively coupled to the print server.

76. The printer system of claim 75 wherein the client logs into the print server prior to submitting the print job.

77. The printer system of claim 75 wherein the web print server sends a preview image of the print job to the client before sending the print file to the printer.

78. The printer system of claim 75, further comprising means adapted to obtaining user consent for a cost associated with printing the document.

79. The computer-readable medium of claim 78 wherein the cost is a cost per page.
